(19) United States
(12) Patent Application Publication
(10) Pub. No.: US 2015/0317387 A1
(43) Pub. Date: Nov. 5, 2015

(54) Collaborative Iterative Design

(71) Applicants: Brandon Michael Heenan, Seattle, WA (US); Jeffrey Eric Wickenheiser, Bellevue, WA (US)

(72) Inventors: Brandon Michael Heenan, Seattle, WA (US); Jeffrey Eric Wickenheiser, Bellevue, WA (US)

(21) Appl. No.: 14/269,183

(22) Filed: May 4, 2014

(51) Int. Cl. G06F 17/30

(52) U.S. Cl. CPC G06F 17/30648; G06F 17/30864; G06F 17/30958; G06F 17/30525; G06F 17/3053

(57) ABSTRACT

Apparatus, systems, and methods to enable collaborative iterative development of an idea and/or design through the use of acyclic directed graphs. For each graph, an initial node may be established, containing a starting idea or invention. Additional nodes may then be added by users, where each node may be a revision of its direct predecessor, and may have zero, one or multiple direct successors.

### BACKGROUND

1. Technical Field

The instant application relates to the field of collaborative computing and a system to expand, revise and refine an idea or invention by a group of users.

2. Description of the Related Art

Current technology has enhanced the ability to collaborate on projects both locally and worldwide. Inventions exist that provide tools and methods to aid in this collaboration, but limitations of these inventions prevent competing ideas that endeavor to solve the same problem from evolving effectively.

Existing tools, such as Internet Relay Chat, messaging boards, forums, and document collaboration software form a venue for users to collaborate. Typically, these tools provide a mechanism for discussion, and allow users to add items, modify existing items, or suggest changes. Tools that support revision history typically support revisions only in a linear fashion, wherein each new revision is based on the latest previous revision.

Existing solutions do not provide an effective enough collaborative model to enable users to iterate on ideas in such a way that they can expand, revise and refine any existing revision of an idea, and expand on competing ideas, while preserving all existing content and allowing other users to also expand, revise and refine the new revision or any previous revision.

Further, current solutions that enable collaboration and design do not adequately scale between many users in different organizations, or work adequately with users who are not acting for any organization. Current solutions are focused on enabling discussion (e.g. Internet relay chat, messaging boards), or enabling collaborative design between small work groups where users know each other and/or work for an organization.

Piller et al. had filed a patent application, Ref: US20040181417, which describes a collaboration model that facilitates allowing users to post ideas, inviting experts to review their idea, and to receive comments and votes on their idea. A disadvantage of this solution is that it requires a facilitator to be responsible for guiding the idea through its design, and other users are limited to providing feedback to that process. Further, it only allows for a linear progression of an idea, and does not allow for the evolution of independent revisions.

Laurin et al.'s patent application, Ref: US20110093539, suffers from similar limitations. It allows a user to submit an idea, and for users to comment on ideas, but control of the process is given to a facilitator. Similar to Piller, it also only allows for the linear progression of an idea.

Greenburg et al. describe in their patent application, Ref: US20070094601, a hierarchical tree data structure for collaborative design. This solution allows for multiple users to modify components of a design, but as someone skilled in the art would recognize, this solution limits the ability of multiple users from making different design decisions about the same component, components which have dependencies, and/or adding and removing interconnected components, while preserving the plurality of different designs and allowing for future revisions from any existing design.

### SUMMARY

The technologies disclosed in the present application generally relate to apparatus, systems and methods that allow for users to collaborate to develop and evolve ideas or designs. Acyclic directed graphs may be used, where an initial idea and/or design authored by a user may form the initial node in a graph. Users, which may include the original author or other authors, may add additional nodes to a graph. Each new node may be a revision of an existing node in the graph, and that existing node provides the basis for the new node. The revision may consist of additions, deletions, or changes, and this new node becomes connected to the node which was the basis for this revision in such a way that the new node is the head, and the node that served as the basis is the tail. Each node may contain one or more data items, such as, but not limited to, text, images, schematics, specifications, and each revision may include changes to one or many of these items, as well as the addition of new items or deletion of existing items.

In one aspect of the present application, a voting system, consisting of an interaction for users to like or dislike a node, may be used to rank nodes. In another aspect of the present application, this ranking may be further used to choose which nodes are displayed to a user.

In another aspect of the present application, metadata, which may include a description, images, categories and/or tags, may be associated with a graph.

In another aspect of the present application, metadata may be assigned to a portion of a node by a user. Users may approve or disapprove of the metadata, and the system may evaluate the applicability of this metadata based on the approvals and disapprovals.

In another aspect of the present application, users may add comments to a node or a part thereof, or reply to an existing comment. In one aspect of the present application, users who create a node may reference one or more comments as having influenced the design contained in that node.

In another aspect of the present application, nodes may be added such that they are the head node of multiple tail nodes, where the head node may be evolved from those tail nodes, such that the ideas and/or designs in the head node are evolved from the ideas and/or designs in the tail nodes.

In another aspect of the present application, graphs may be voted on by users, wherein users may like or dislike a graph. In one aspect of the present application, these votes may be evaluated by the system along with factors including, but not limited to, time since the graph was created, time since the last modification was made to the graph, and graph metadata. This evaluation may be used to create a score for the graph. This score may be used to sort and/or filter the graphs displayed to the user.

In another aspect of the present application, graphs may be split, such that a user may create a new graph by using an existing node on an existing graph as the initial node on the new graph, and graphs may be merged, such that a new node may be created as the head of multiple tail nodes, where the tail nodes exist on different graphs.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a graph with a number of nodes which each represent a design, and together represent the evolution of a design over time, according to one embodiment; in this embodiment, each node has been voted on by users and has been scored based on those votes.

FIG. 2 is a graph where a subset of nodes to be displayed to a user are annotated, based on the structure of the graph and votes received, according to one embodiment.

FIG. 3 is an illustrative screen capture of a graph being displayed to a user where some nodes are hidden, and there is a voting interaction for all visible nodes, according to one embodiment.

FIG. 4 is an illustrative screen capture of a node being authored by a user, according to one embodiment; in this embodiment, several subsections of the node have been tagged with metadata.

FIG. 5 is an illustrative screen capture of comments made on a particular node by users, according to one embodiment; in this embodiment, a user may author a new node based on one of the comments.

FIG. 6 is an illustrative screen capture of the list of graphs presented to a user, according to one embodiment.

FIG. 7 is a diagram illustrating an example of a system capable of supporting Collaborative Iterative Design, according to one embodiment.

FIG. 8 is a component diagram of a computing device to which a Collaborative Iterative Design process may be applied, according to one embodiment.

### DETAILED DESCRIPTION

The present application enables collaborative iterative development of an idea and/or design. The invention may be practiced in various embodiments.

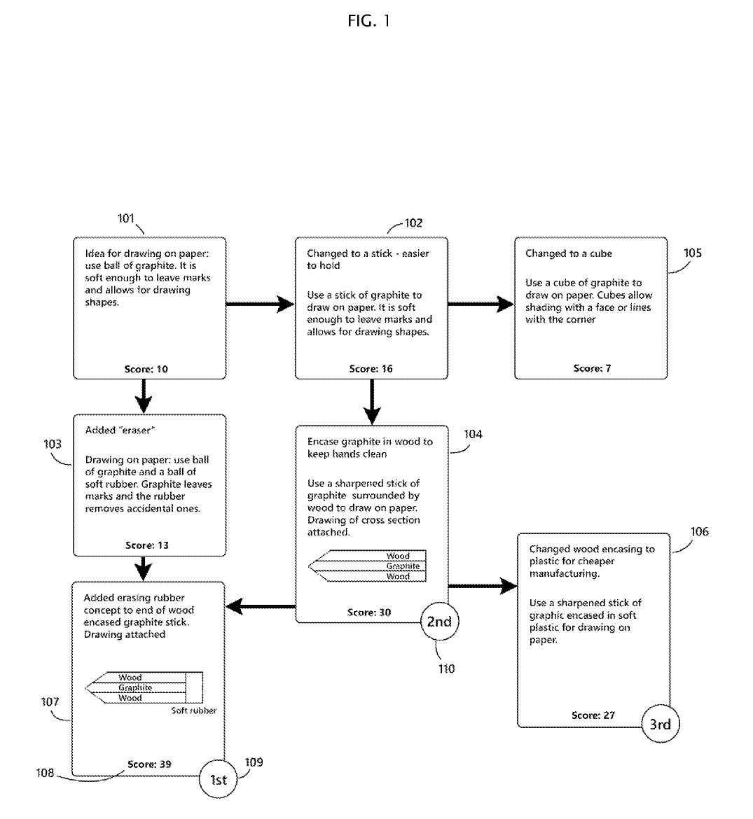

FIG. 1 shows an acyclic directed graph in a conceptual fashion of one possible embodiment of the invention. The state of graph after some time is shown, where each node independently represents an idea/design. There is a score shown (Score 108) on each node that may be based on the results of voting by users. In this example, Node 101 represents the initial node present in the graph, and Node 102 and Node 103 are new nodes added by users, and where each of these nodes (Node 102 and Node 103) represents an evolution of the idea/design in Node 101. Likewise, Node 104 and Node 105 are evolutions of Node 102, and Node 106 is an evolution of Node 104. Node 107 has two tail nodes, as it represents an evolution of ideas/designs from both Node 103 and Node 104. Different nodes in the graph may be authored by different users, and a single user may be responsible for adding one or more nodes in the graph. Further illustrated in this figure is how the highest scored nodes may be ranked, such that Node 107 represents the node with the highest score, labeled with Label 109; Node 104 represents the node with the second highest score, labeled with Label 110.

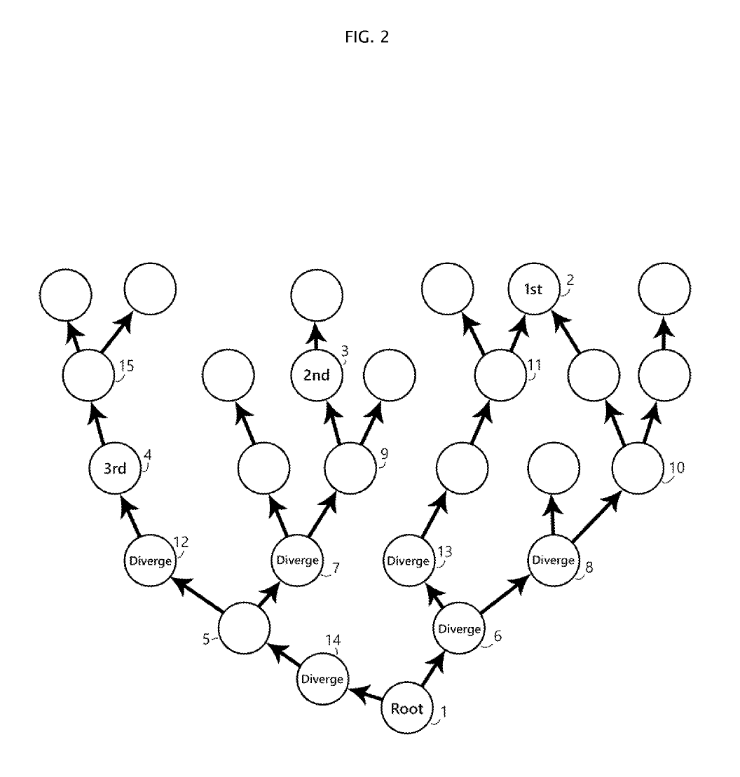

FIG. 2 shows an acyclic directed graph and one possible embodiment of the algorithm used to display a subset of nodes to the user. In FIG. 2, the nodes which are annotated (with the words “Root”, “Diverge”, “1st”, “2nd”, or “3rd”) (Node 1, Node 2, Node 3, Node 4, Node 6, Node 7, Node 8, Node 12, Node 13, Node 14) represent the nodes that would be initially shown to a user viewing the graph. The nodes which are not annotated represent nodes that would be hidden or collapsed in the initial view. In this example, Node 1 was the initial node of the graph, apparent because it has no tail nodes. In this one possible embodiment of the present application, Node 1 is always shown to the user because it was the initial node in the graph. Each other node in the graph represents an evolution of the idea/design described in its tail node, and therefore they all, either directly or indirectly, evolved from Node 1. Further, Node 2, Node 3, and Node 4 represent the top three highest scoring nodes, and are therefore are also initially shown to users. In this possible embodiment, the top three highest scoring nodes are chosen to display to the user, although other implementations may use more or less than the top three.

In several cases in FIG. 2, examples are shown where a node is the tail node to multiple head nodes (Node 1, Node 5, Node 6, Node 7, Node 8, Node 9, Node 10, Node 11, Node 15), which may mean competing ideas/designs diverged from those nodes. In some cases, multiple branches from that node have led to one or more of the highest scoring nodes (Node 1, Node 5, Node 6). In other cases, there are no branches that lead to one of the highest scoring nodes (Node 15), or there is only one branch that leads to one of the highest scoring nodes (Node 7, Node 8, Node 9, Node 10, Node 11). Where multiple nodes (Node 1, Node 5, Node 6) have led to a highest scoring node (Node 2, Node 3, Node 4), all the head nodes of those nodes (Node 6, Node 14, Node 7, Node 12, Node 8, Node 13) leading to a highest scoring node (Node 2, Node 3, Node 4) may be shown to the user (marked as “Diverge” for illustrative purposes). In this one possible embodiment, because Node 1 has diverging branches (Node 6, Node 14) which both lead to a highest scoring node (Node 2, Node 3, Node 4), Node 6 and Node 14 are shown. Further, because Node 5 has diverging branches (Node 7, Node 12) which both lead to a highest scoring node (Node 3, Node 4), Node 7 and Node 12 are shown. Further, because Node 6 has diverging branches (Node 8, Node 13) which both lead to a highest scoring node (Node 2), Node 8 and Node 13 are shown.

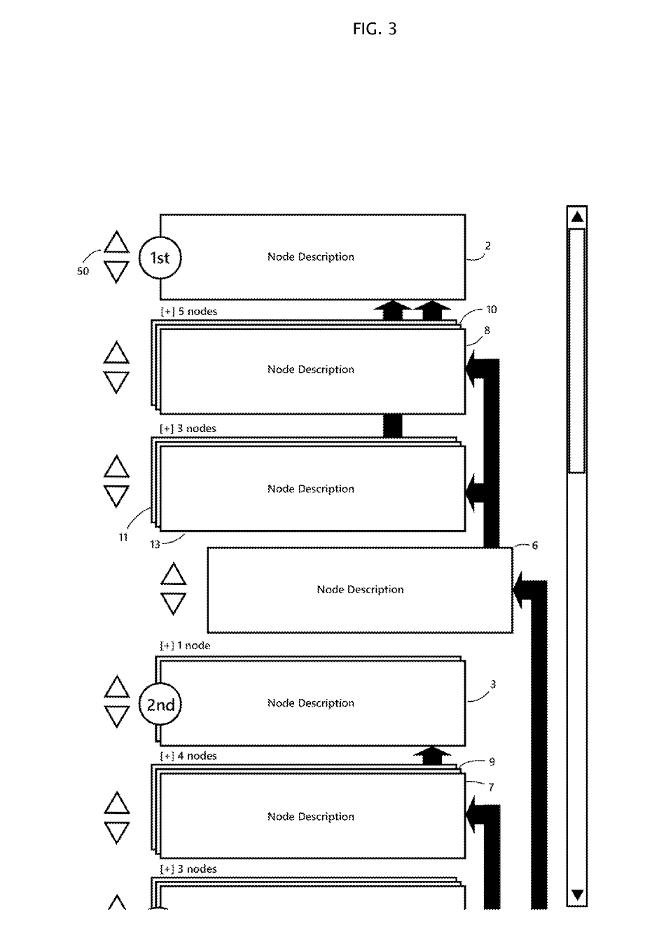

FIG. 3 shows one possible embodiment of the visual representation to a user of the current state of a graph described in FIG. 2. In this example, each rectangle represents a node, where nodes fully shown in the foreground (Node 2, Node 8, Node 13, Node 6, Node 3, Node 7) are those selected to be initially shown to a user based on the implemented algorithm, and nodes in the background (Node 10, Node 11, Node 9) represent nodes not initially displayed to the user. One possible embodiment of the voting interaction is also shown (Voting Interaction 50).

In one possible embodiment, users may be able to assign metadata to a graph, which applies to all of the nodes within the graph. This metadata may include a title, description, images, categories, and/or tags. In another possible embodiment, an interaction may exist where users vote for or against specific metadata items.

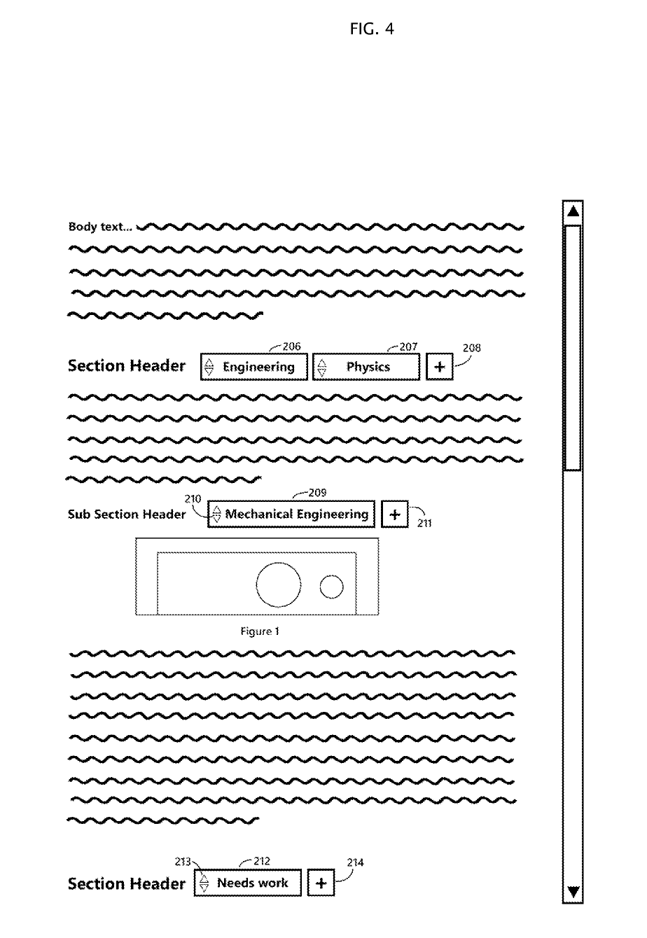

FIG. 4 shows one possible embodiment by way of example that illustrates a plurality of sections, where each may represent part of the design, and where each may contain text, diagrams, and/or other data items. This example also illustrates how parts of a design may be tagged with metadata by users (Metadata 206, Metadata 207, Metadata 209, Metadata 212), and that this metadata may be voted on by users (Voting Interaction 210, Voting Interaction 213). New tags may be added by users (Interaction 208, Interaction 211, Interaction 214).

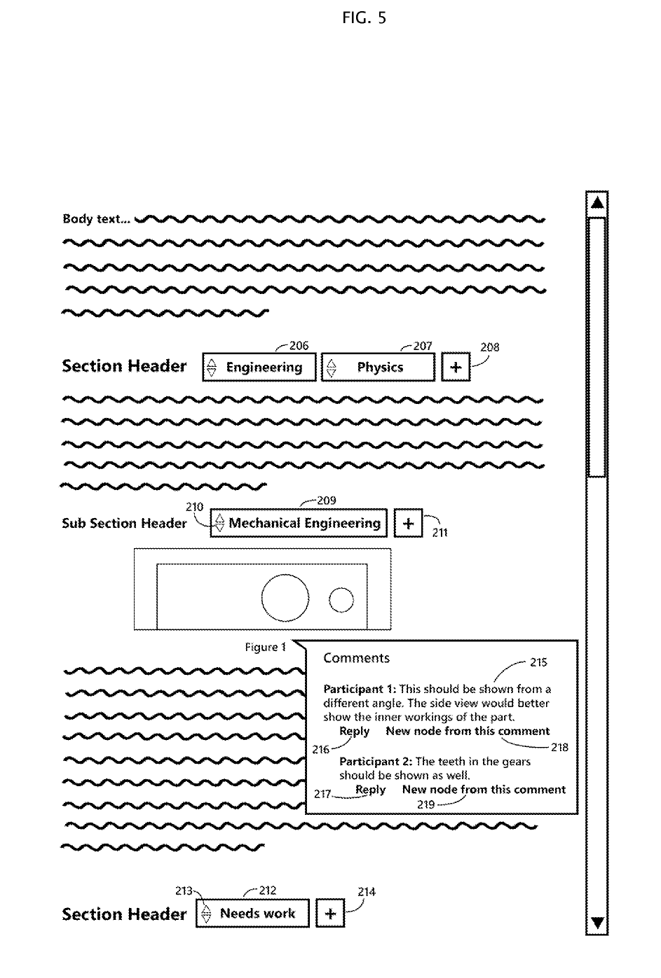

FIG. 5 shows one possible embodiment by way of example that illustrates the ability for users to add comments to a portion of a node (Comment 215), or reply to existing comments (Interaction 216, Interaction 217). The example also illustrates an interaction for a user to create a new node in response to a comment (Interaction 218, Interaction 219), wherein the existing node would become the tail for the new node, and the new node may reference the comment as having influence on the idea/design of the new node.

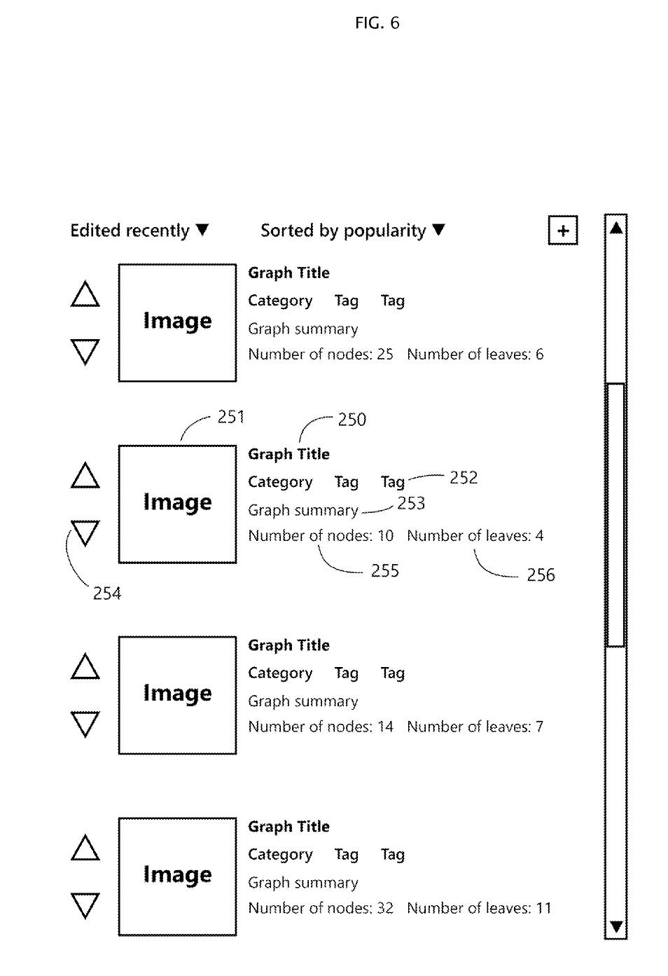

FIG. 6 shows one possible embodiment of how a plurality of graphs may be displayed to a user. In this example, titles from the highest scoring nodes from each graph are displayed (Title 250), along with an image (Image 251), summary (Summary 253), and other related data (Metadata 252). The shape of the graph is also summarized with the number of nodes (Data Item 255) and the number of leaves (Data Item 256), wherein a leaf is defined to be a node which is not the tail node to any other node.

FIG. 6 shows another possible embodiment, wherein a voting interaction exists to allow users to specify if they like or dislike the graph (Voting Interaction 254).

In one possible embodiment, a graph may be split, such that a new graph may be created with the initial node on the new graph being a copy of an existing node on an existing graph. In another possible embodiment, multiple graphs may be merged into a single graph, such that there exists a node in the new graph which has tail nodes in each of the original graphs. In another possible embodiment, an interaction exists for users to vote on the split or merge.

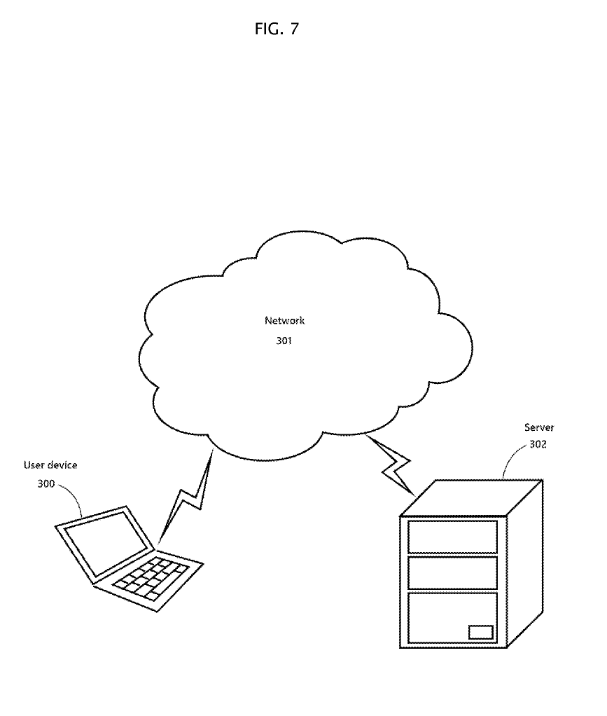

FIG. 7 is a block diagram illustrating an example of a system capable of supporting Collaborative Iterative Design according to one embodiment.

Network 301 may include Wi-Fi, cellular data access methods, such as 3G or 4GLTE, Bluetooth, Near Field Communications (NFC), the internet, local area networks, wide area networks, or any combination of these or other means of providing data transfer capabilities. In one embodiment, Network 301 may comprise Ethernet connectivity. In another embodiment, Network 301 may comprise fiber optic connections.

User Device 300 may be a smartphone, tablet, laptop computer, desktop computer, or other device, and may have network capabilities to communicate with Server 302.

Server 302 may include one or more computers, and may serve a number of roles. Server 302 may be conventionally constructed, or may be of a special purpose design for processing data obtained from Collaborative Iterative Design. One skilled in the art will recognize that Server 302 may be of many different designs and may have different capabilities.

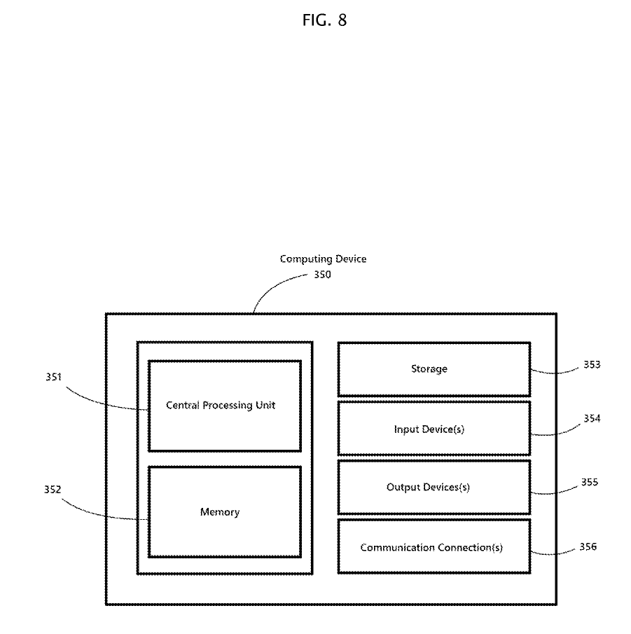

FIG. 8 is a component diagram of a computing device to which a Collaborative Iterative Design process may be applied according to one embodiment. The Computing Device 350 can be utilized to implement one or more computing devices, computer processes, or software modules described herein, including, for example, but not limited to a mobile device. In one example, the Computing Device 350 can be used to process calculations, execute instructions, and receive and transmit digital signals. In another example, the Computing Device 350 can be utilized to process calculations, execute instructions, receive and transmit digital signals, receive and transmit search queries and hypertext, and compile computer code suitable for a mobile device. The Computing Device 350 can be any general or special purpose computer now known or to become known capable of performing the steps and/or performing the functions described herein, either in software, hardware, firmware, or a combination thereof.

In its most basic configuration, Computing Device 350 typically includes at least one Central Processing Unit (CPU) 351 and Memory 352. Depending on the exact configuration and type of Computing Device 350, Memory 352 may be volatile (such as RAM), non-volatile (such as ROM, flash memory, etc.) or some combination of the two. Additionally, Computing Device 350 may also have additional features/functionality. For example, Computing Device 350 may include multiple CPUs. The described methods may be executed in any manner by any processing unit in computing device 350. For example, the described process may be executed by both multiple CPUs in parallel.

Computing Device 350 may also include additional storage (removable and/or non-removable) including, but not limited to, magnetic or optical disks or tape. Such additional storage is illustrated in FIG. 8 by Storage 353. Computer readable storage media includes volatile and nonvolatile, removable and non-removable media implemented in any method or technology for storage of information such as computer readable instructions, data structures, program modules or other data. Memory 352 and Storage 353 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 350. Any such computer readable storage media may be part of computing device 350. However, computer readable storage media does not include transient signals.

Computing Device 350 may also contain Communications Device(s) 356 that allow the device to communicate with other devices. Communications Device(s) 356 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer readable storage media and communication media. The described methods may be encoded in any computer-readable media in any form, such as data, computer-executable instructions, and the like.

Computing Device 350 may also have Input Device(s) 354 such as keyboard, mouse, pen, voice input device, touch input device, etc. Output Device(s) 355 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used.

Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A computer system implemented method for collaborative, iterative design, comprising:
creating an acyclic directed graph, the graph corresponding to a problem space or goal, based on inputs received from one or more users;
adding a first node to the graph, the first node representing a solution selected from a group consisting of an idea, an invention, and a design, the first node consisting of at least one data item, based on inputs received from one or more users;
adding a second node to the graph, the second node independently representing a solution which has evolved from the solution represented by the first node, the second node consisting of at least one data item, an edge being added which connects the first node to the second node such that the second node is the head node of the edge, based on inputs received from one or more users.

2. The method of claim 1, further comprising:
recording votes corresponding to nodes in the graph, based on inputs received from one or more users, wherein each vote indicates if a user likes or dislikes the solution represented by the node;
calculating scores for each node based on the recorded votes.

3. The method of claim 2, further comprising:
displaying a set of nodes within the graph to a user, including a subset of nodes selected from a group consisting of the highest scoring node(s) in the graph, the initial node(s) authored in the graph, nodes that have been recently authored in the graph, and nodes that are the head nodes to the same tail node and are indirect tail nodes to the highest scoring node(s) in the graph.

4. The method of claim 1, further comprising:
assigning a metadata item to the graph, including a subset selected from a group consisting of a title, description, images, categories, and tags, based on inputs received from one or more users;
recording votes corresponding to the metadata item based on inputs received from one or more users, wherein each vote indicates if a user agrees or disagrees with the applicability of the metadata item;
evaluating the votes to determine if the metadata item will be applied to the graph.

5. The method of claim 1, further comprising:
assigning a metadata item to a node or portion of a node, including a category or tag, based on inputs received from one or more users;
recording votes corresponding to the metadata item based on inputs received from one or more users, wherein each vote indicates if a user agrees or disagrees with the applicability of the metadata item;
evaluating the votes to determine if the metadata item will be applied.

6. The method of claim 1, further comprising:
recording a comment associated with a node in the graph, portion of a node in the graph, or an existing comment, based on inputs received from one or more users.

7. The method of claim 6, further comprising:
marking a node in the graph as being influenced by one or more comments on other nodes in the graph, based on inputs received from one or more users.

8. The method of claim 1, further comprising:
adding a node to the graph, where the node independently represents a solution, and where the node consists of one or more data items, and where the node describes an evolution of the solution from more than one existing node in the graph, and where an edge is added connecting each of these existing nodes to the node such that the node is the head node for each edge, based on inputs received from one or more users.

9. The method of claim 1, further comprising:
recording votes corresponding to the graph based on inputs received from one or more users, wherein each vote indicates if a user likes or dislikes the graph;
calculating a score for the graph based on data including a subset selected from a group consisting of the recorded votes for the graph, time since the graph was created, time since the last node or comment was added to the graph, and metadata items assigned to the graph;
using the scores of each graph to display a sorted and/or filtered list of graphs to a user.

10. The method of claim 1, further comprising:
creating a new graph including a node, based on inputs received from one or more users;
linking the new node to an existing node in an existing graph with an edge, such that the new node is the head node of the edge.

11. The method of claim 1, further comprising:
adding a new node to a new or existing graph, based on inputs received from one or more users;
linking the new node to multiple existing nodes with edges, such that the new node is the head node for each edge, and at least one tail node exists on a different graph.

12. A system, containing a processor, memory coupled to the processor, and components stored in memory comprising:
a component that accepts one or more data items to create a first node in an acyclic directed graph, where the graph represents a problem space or goal, and the node represents a solution selected from a group consisting of an idea, an invention, and a design;
a component that accepts one or more data items to create a second node in the graph, where the second node independently represents a solution, and that solution is an evolution of the first node, and an edge being added connecting the first node to the second node such that the second node is the head node of the edge.

13. The system of claim 12, further comprising:
a component that accepts votes that correspond to nodes in the graph;
a component that calculates scores for each node based on the votes.

14. The system of claim 13, further comprising:
a component that selects a set of nodes to display, including a subset of nodes selected from a group consisting of a highest scoring node or nodes in the graph, an initial node or nodes authored in the graph, nodes that have been recently authored in the graph, and nodes that are the head nodes to the same tail node and are indirect tail nodes to a highest scoring node in the graph.

15. The system of claim 12, further comprising:
a component that accepts a metadata item to be assigned to the graph, including a subset selected from a group consisting of a title, description, images, categories, and tags;
a component that accepts votes that correspond to the metadata item;
a component that evaluates the votes to determine if the metadata item will be applied to the graph.

16. The system of claim 12, further comprising:
a component that accepts a metadata item to be assigned to a node or portion of a node, including a category or tag;
a component that accepts votes that correspond to the metadata item;
a component that evaluates the votes to determine if that metadata item will be applied.

17. The system of claim 12, further comprising:
a component that accepts a comment associated with a node in the graph, portion of a node in the graph, or an existing comment.

18. The system of claim 17, further comprising:
a component that accepts the marking of a node in the graph as being influenced by one or more comments on other nodes.

19. The system of claim 12, further comprising:
a component that accepts adding a node to the graph, where the node independently represents a solution, and the node consists of one or more data items, and where the node represents an evolution of the solution from more than one existing node in the graph, and where an edge is added connecting each of these existing nodes to the node such that the node is the head node for each edge.

20. The system of claim 12, further comprising:
a component that accepts votes that corresponds to the graph;
a component that calculates a score for the graph based on data including a subset selected from a group consisting of the recorded votes for the graph, time since the graph was created, time since the last node or comment was added to the graph, and metadata items assigned to the graph;
a component that uses the scores of each graph to select and/or order a set of graphs to display.

21. The system of claim 12, further comprising:
a component that creates a new graph, including a node, such that the new node is linked to an existing node in an existing graph with an edge, such that the new node is the head node of the edge.

22. The system of claim 12, further comprising:
a component that accepts one or more data items to add a new node to a new or existing graph, such that the new node is linked to multiple existing nodes with edges, and such that the new node is the head node for each edge, and at least one tail node exists on a different graph.

23. An apparatus, containing a computer readable storage medium, which contains instructions that execute on a processor, comprising:
creating an acyclic directed graph, the graph corresponding to a problem space or goal, based on inputs received from one or more users;
adding a first node to the graph, the first node representing a solution selected from a group consisting of an idea, an invention, and a design, the first node consisting of at least one data item, based on inputs received from one or more users;
adding a second node to the graph, the second node independently representing a solution which has evolved from the solution represented by the first node, the second node consisting of at least one data item, an edge being added connecting the first node to the second node such that the second node is the head node of the edge, based on inputs received from one or more users.

24. The apparatus of claim 23, further comprising:
recording votes corresponding to nodes in the graph, based on inputs received from one or more users, wherein each vote indicates if a user likes or dislikes the solution represented by the node;
calculating scores for each node based on the recorded votes.

25. The apparatus of claim 24, further comprising:
displaying a set of nodes within the graph to a user, including a subset of nodes selected from a group consisting of the highest scoring node(s) in the graph, the initial node(s) authored in the graph, nodes that have been recently authored in the graph, and nodes that are the head nodes to the same tail node and are indirect tail nodes to the highest scoring node(s) in the graph.

26. The apparatus of claim 23, further comprising:
assigning a metadata item to a graph, including a subset selected from a group consisting of a title, description, images, categories, and tags, based on inputs received from one or more users;
recording votes corresponding to the metadata item based on inputs received from one or more users;
evaluating the votes to determine if the metadata item will be applied to the graph.

27. The apparatus of claim 23, further comprising:
assigning a metadata item to a node or portion of a node, including a category or tag, based on inputs received from one or more users;
recording votes corresponding to the metadata item based on inputs received from one or more users;
evaluating the votes to determine if the metadata item will be applied.

28. The apparatus of claim 23, further comprising:
recording a comment associated with a node in the graph, portion of a node in the graph, or an existing comment, based on inputs received from one or more users.

29. The apparatus of claim 28, further comprising:
marking a node in the graph as being influenced by one or more comments on other nodes, based on inputs received from one or more users.

30. The apparatus of claim 23, further comprising:
adding a node to the graph, where the node independently represents a solution, and where the node consists of one or more data items, and where the node describes an evolution of the solution from more than one existing node in the graph, and where an edge is added connecting each of these existing nodes to the node such that the node is the head node for each edge, based on inputs received from one or more users.

31. The apparatus of claim 23, further comprising:
recording votes corresponding to the graph based on inputs received from one or more users;
calculating a score for the graph based on data including a subset selected from a group consisting of the recorded votes for the graph, time since the graph was created, time since the last node or comment was added to the graph, and metadata items assigned to the graph;
using the scores of each graph to display a sorted and/or filtered list of graphs to a user.

32. The apparatus of claim 23, further comprising:
creating a new graph including a node, based on inputs received from one or more users;
linking the new node to an existing node in an existing graph with an edge, such that the new node is the head node of the edge.

33. The apparatus of claim 23, further comprising:
adding a new node to a new or existing graph, based on inputs received from one or more users;
linking the new node to multiple existing nodes with edges, such that the new node is the head node for each edge, and at least one tail node exists on a different graph.
